(19) United States
(12) Patent Application Publication
(10) Pub. No.: US 2002/0093458 A1
(43) Pub. Date: Jul. 18, 2002

(54) Use of phase coded permeability lensing to obtain directional information in electro-magnetic radiation

(75) Inventor: Bijan K. Amini, (US)

Correspondence Address: LAW OFFICES OF DAVID MCEWING, 4582 KINGWOOD DRIVE, BOX 118, KINGWOOD, TX, 77345, US

(73) Assignee: EM-Tech LLC

(21) Appl. No.: 10/039,834

(22) Filed: Jan. 2, 2002

Related U.S. Application Data
(63) Continuation-in-part of application No. 09/734,525, filed on Dec. 11, 2000, now Pat. No. 6,351,245.
(60) Provisional application No. 60/170,173, filed on Dec. 10, 1999.

(51) Int. Cl. H01Q 1/00

(52) U.S. Cl. 343/787

(57) ABSTRACT

The present invention relates to a method and apparatus for obtaining measurements of induced resistivity of objects from spaces such as within a down-hole hydrocarbon production well. The invention also relates to measuring the location or direction of objects based upon measured responses from objects engaged or impinges by one or more transmitted signals having different phase and directional orientation. The invention relates to generating at least one signal or wave and transmitting it through a plurality of different materials that may have varying properties of density, magnetic permeability and dielectric that may each emit a separate signal with altered phase and directional orientation. When used with electromagnetic signals, the resistivity of an object or media can provide useful information regarding the composition and the location of object or media. Such embodiments of the present invention utilize the principles of Magnetic Antenna™ and Magnetic Lensing™ to obtain information regarding the location and properties of the target object.

### CROSS REFERENCE TO RELATED APPLICATIONS

This application is a continuation in part of U.S. Application No. Ser. 09/734,528, filed Dec. 11, 2000, which claims the benefit of U.S. Provisional Application No. 60/170,173, filed Dec. 10, 1999.

### BACKGROUND OF THE INVENTION

1. Field of Use

The present invention relates to a method and apparatus for obtaining measurements of induced resistivity of objects from confined spaces such as within a down-hole hydrocarbon production well. It is well known that measuring the resistivity of an object or media can provide useful information regarding the composition and the location of object or media. The present invention utilizes the principles of Magnetic Antenna™ and Magnetic Lensing™ to obtain information regarding the location and properties of the target object. The present invention also relates to a method transmitting magnetic, electric, or acoustic energy through varying media to obtain phase differences in the energy that can be directionally oriented.

2. Description of Related Art

In many applications of Inductive Resistivity Measurements (IRM), limitations of space or topography prevent the use of multiple antennas arrays. This lack of multiple antennas arrays causes the loss of directional information from received EM waves. An example of space limitations is in the down-hole environment of oil wells. IRM is used in this application for reservoir mapping or the detection of interfaces among oil, water and gas in a geologic formation. The accurate knowledge of the direction of the reflected EM wave is very important in these uses of IRM. Directionality determination must be made in both the vertical and azmuthal senses. Therefore there is a need for a device to encode the radiated EM signals in a way that yields directionality in space limited environments.

One requirement when obtaining useful or reliable Inductive Resistivity Measurements (IRM) is the ability to determinate the direction, if not the location, of the target object in which resistivity has been induced and now subject to measurement. This directionality makes it possible to determine the location of various objects in which the resistivity has been induced. A customary method of locating the source, or at least ascertaining the direction of the induced signal, is to utilize multiple antennas or signal receiving devises. Measuring the signal from multiple locations provides multiple references points for determining the location based upon conventional coordinate systems or other known methods. Determining the location or the direction of an object in which resistivity signals are induced has provided significant challenges. Prior to the present invention, the utility of IRM in such applications has been severely limited.

### SUMMARY OF THE INVENTION

The present invention utilizes Magnetic Antenna and Magnetic Lensing techniques to overcome the limitations that heretofore have prevented multiple measurement to be taken from separate locations. Simply stated, the method and apparatus of the present invention discloses creating phase changes in a pulsed or oscillating magnetic flux transmitted from a magnetic flux transmitter. The phase changes are created in a controlled manner by utilization of the magnetic phase coded permeability lensing effect. As the transmitted oscillating magnetic flux passes through differing sections of a magnetic antenna, the phase of the original oscillating flux is modified into multiple phases. These multiple phases are also oriented in different directions. Accordingly, a flux from a single source and having a single phase, is altered into multiple and easily distinguishable flux signals. Further, since the multiple flux signals can each be oriented in different directions by the magnetic lens effect, it is possible to utilize the different induced phases from one or more magnetic flux transmitter to induce responsive oscillating flux signals within the target object from one or more of known locations relative to one or more signal receiving devices. These results in multiple Induced Resistivity Measurements that can provide the location or, at a minimum, the direction of the target object from the separate signal receiving devise.

Further, the invention can be used to create phase changes in other energy signals, such as acoustic signals and the electric component of an electromagnetic wave.

Accordingly, it is an object of the present invention to provide a method and apparatus for transmitting an electromagnetic signal through materials having varying magnetic permeability, electrical conductivity, density or geometry to obtain phase changes in the signals that may be directionally oriented.

It is another object of the present invention to utilize one or more receiving devices to determine the location, as well as direction, of one or more electrically conductive objects within a geologic formation or other media surrounding the invention.

It is an object of the present invention to provide a method and apparatus for creating multiple and distinguishable signals from a single source and utilizing at least one such signal for locating objects.

It is another object of the invention to transmit electrical signals through materials having varying dielectric properties to obtain phase changes in the signal that may be directionally oriented.

It is yet another object of the invention to transmit acoustic signals through materials of varying densities to obtain phase changes in the signal that may be directionally oriented.

### BRIEF DESCRIPTION OF THE DRAWINGS

The accompanying drawings, which are incorporated in and constitute a part of the specification, illustrate preferred embodiments of the invention. These drawings, together with the general description of the invention given above and the detailed description of the preferred embodiments given below, serve to explain the principles of the invention for resistivity measurements within a confined space of a hydrocarbon production well.

FIG. 1 illustrates a collar device attached to production tubing or drill pipe comprising distinct sections having differing permeability properties.

FIG. 1A illustrates a cross sectional view of the embodiment.

FIG. 2 illustrates another embodiment of the invention.

FIG. 2A illustrates a cross sectional view of the embodiment of FIG. 2.

FIG. 3 illustrates the varying magnetic permeability, dielectric or density of different sections of the invention.

FIG. 3A illustrates the relative arc segments of the different sections.

FIG. 3B illustrates the differing arcs within which signals from differing segments are emitted

FIG. 3C illustrates the directional orientation of differing signal fields emitted from the differing sections of one embodiment of the invention.

FIG. 3D illustrates the directional orientation of energy concentrations emitted from another embodiment of the invention.

FIG. 4 illustrates an embodiment wherein the generator of the multiple phase oriented signals located separate from the signal receiver on production well tubing.

FIG. 5 is a schematic drawing of some of the components utilized in some embodiments of the invention.

The above general description and the following detailed description are merely illustrative of the subject invention, and additional modes, advantages and particulars of this invention will be readily suggest to those skilled in the art without departing from the spirit and scope of the invention.

### DETAILED DESCRIPTION OF THE PREFERRED EMBODIMENTS

The invention subject of this application utilizes one or more sources for generating an oscillating or pulsed energy sources such as an ac generated electromagnetic wave. The signal may be transmitted from the signal generator in a distinguishable phase. Subsequent transmission through media having differing properties can cause the signal to attenuate or shift in phase. Differing media will have differing effect on the energy signal. Transmission of light through differing media has well known results in attenuation, direction and phase. Of course the attenuation and phase change can differ with the frequency of the original signal. The differing phase change can be used in the present invention in a controlled manner with one or more generated signals transmitted through multiple media or material of known properties and oriented in a known configuration. The signals emitted from each material will have differing properties, particularly differing phase. Since the each differing material may have distinct orientation to the transmitter and to any signal receiving device(s), it may be possible to ascertain the location of an object responding to the various signals of differing phase. This directionality can be enhanced by controlled selection of material and the strength of signals transmitted into the material. In regard to the transmission of electromagnetic waves through magnetically permeable material, the refraction or change in direction of magnetic flux emitted through the material can be controlled by selectively modifying the relative magnetic permeability of the material. This technique is termed the “Magnetic Lensing”™ effect.

In the preferred embodiment of the invention subject of this application one or more sources may be utilized for generating magnetic flux. The flux can be generated utilizing a pulsed dc generated magnetic flux or an oscillating magnetic flux. The magnetic flux oscillates or pulses at a controlled frequency and phase.

This flux is engaged with a magnetic antenna comprised of electrically conductive and magnetically permeable material, e.g., a ferromagnetic metal. It will be appreciated that such material typically acts as a barrier to the transmission of electromagnetic energy or signals. These materials are termed herein as “EM barriers” or “barrier materials.” The present invention teaches use of barrier materials of differing permeability, conductivity and shape to construct a lensed magnetic antenna for emitting oscillating flux of differing phase and for directing or focusing oscillating magnetic flux in a controlled manner. These lensed magnetic antenna components (or “antenna”) can be arranged or configured in multiple designs in accordance with the particular application.

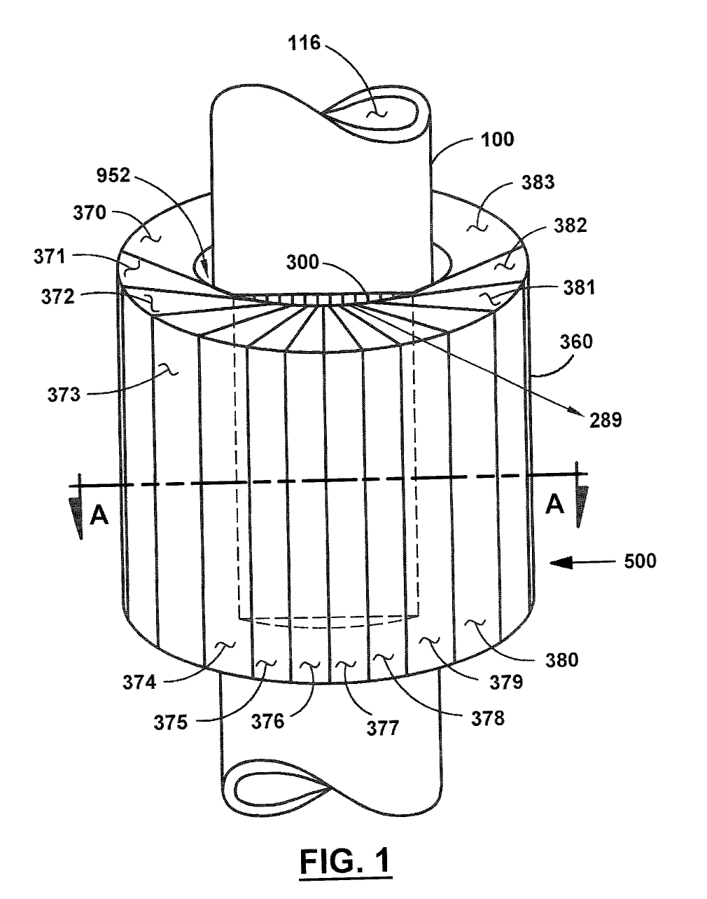

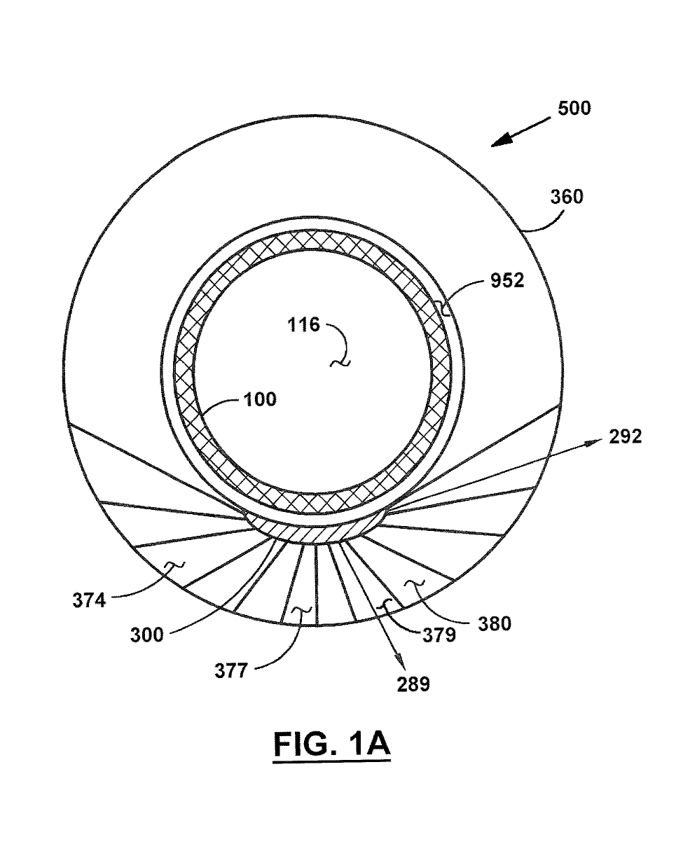

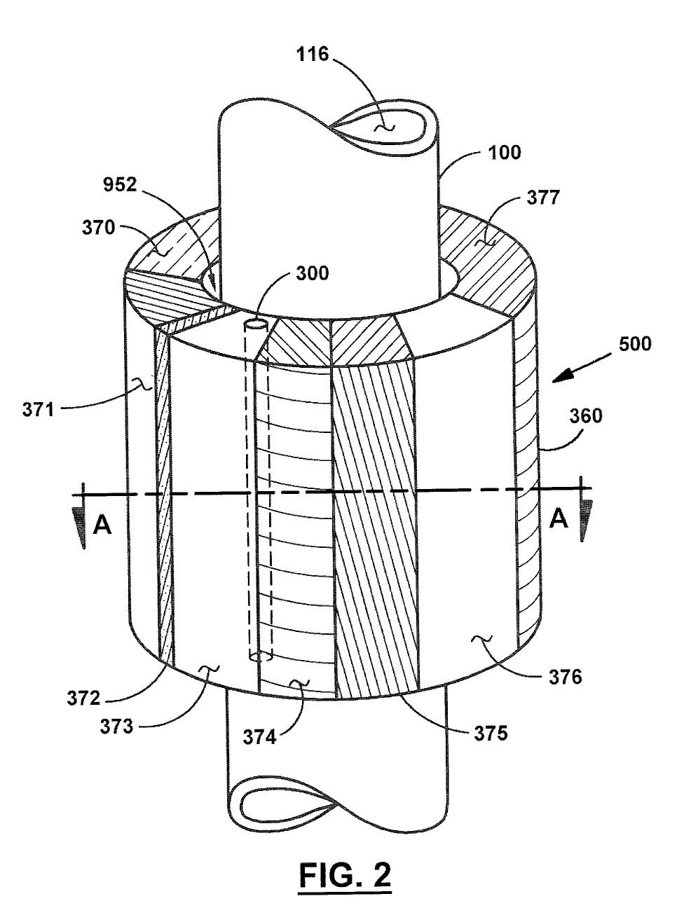

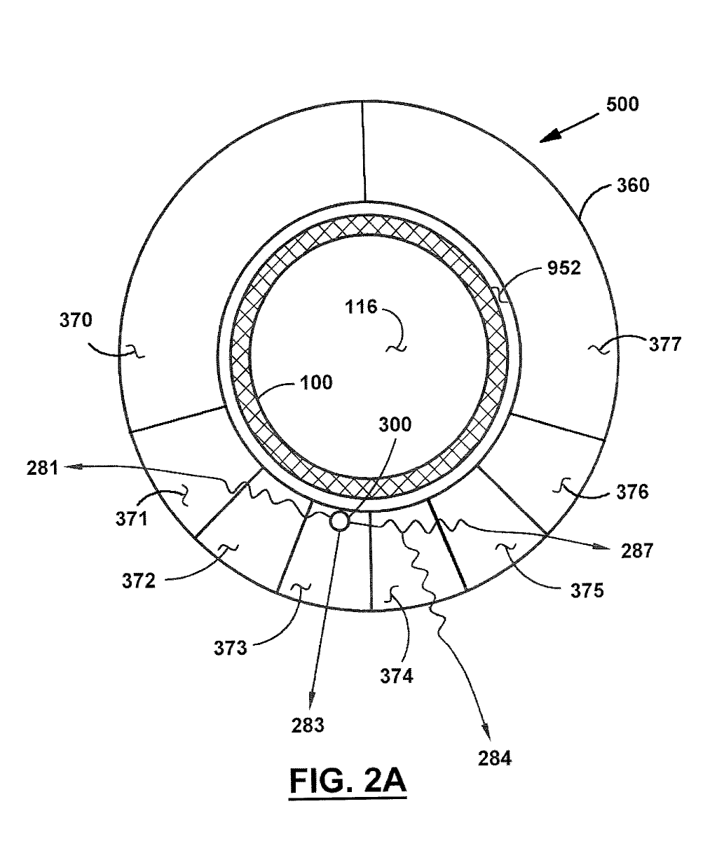

The antenna components can be configured in a “collar type” antenna shape around a pipe or similar object as illustrated in FIGS. 1, 1A, 2 and 2A. The lensed magnetic antenna 360 can be made of multiple sections of differing material or like material of differing shape, e.g., thickness. It will be appreciated that the materials of differing thickness or composition will have differing net permeability and conductivity. As a result, the oscillating magnetic flux from the transmitter 300 will be both phase shifted and directed as the portions of flux signal are transmitted through differing segments of the lensed magnetic antenna. As the antenna components are also conductive, the oscillating magnetic flux will also induce eddy currents within the material. These eddy currents will also vary in phase and orientation.

FIG. 1 illustrates separate antenna segments 370 through 383 configured into a single collar shaped lensed magnetic antenna 360. Separate portions of the oscillating flux emitted from transmitter 300 are transmitted outward through separate antenna segments in the manner indicated by vector 889. The power supply, amplifiers, signal generator, or receiver comprising apparatus of the invention 500 are not shown. Means to partially saturate the permeable segments comprising the lensed magnetic antenna 360 are also not shown. It may be anticipated that the means to couple with the antenna may be required to reduce the permeability of at least some of the segments in order that the oscillating magnetic flux can couple and penetrate into the surface of the antenna 360. This may require placement of one or more saturation coils, not shown, within the space 952 proximate to the transmitter 300.

Although it is anticipated that the invention may be used in conjunction with an outer well casing (not shown) comprised of an EM barrier material and in which the production tubing 100 and antenna 360 are positioned, embodiments of the invention may include use of non-permeable casing material. In this or other embodiments, it may be deemed advantageous to place the saturation coil (not shown) or other components of the invention inside the annulus 116 of the production tube 100.

FIG. 1A shows the arrangement of the oscillating magnetic flux transmitter 300 with the individual antenna segments, e.g., 374, 377, etc. It will be noted that each antenna segment is immediately adjacent to the transmitter 300. It will be appreciated that a small gap or spacing (not shown) of a known thickness may be maintained between the transmitter 300 and the lensed magnetic antenna 360.

FIG. 1A shows oscillating magnetic flux of a single phase transmitted from the transmitter 300. Since the flux is transmitted through segments of the antenna 360 having differing permeability or thickness, the oscillating magnetic flux within each segment will experience differing phase shifts. This results in phase angles θ₁ and θ₂. Alternatively, these antenna segments could be of uniform thickness but using different materials with different permeability values. The segments of differing material could be configured in a predetermined phase-coded pattern. This phase coded configuration could be related to a particular directional orientation. This directional orientation of phase shift could be used to mark or encode magnetic flux induced in a conductive target object. The properties of the received signals from the differing phased magnetic flux induced in the target object could provide information related to the location or direction of the object. Since targets also can change the phase of an EM wave, the spatial relationship of the phase-coded configuration would be important in determining the returning wave direction.

Further, the differing permeability of antenna segments will result in differing relative permeability, i.e., differing degrees of reduced permeability and degrees of magnetic saturation. Therefore, the magnetic flux may be directionally oriented as it is emitted from the surface of the individual segment. This is illustrated in FIG. 1A by the vector lines 289 and 292 not being normal to the outer surface of the respective segment.

It will be appreciated that a phase code configuration be utilized that will be distinctive from possible induced phase changes within the targets.

It will, of course, be beneficial to have knowledge of the expected target object. For example, an advancing waterfront contact target would be changing the EM phase in a different way than stationary targets.

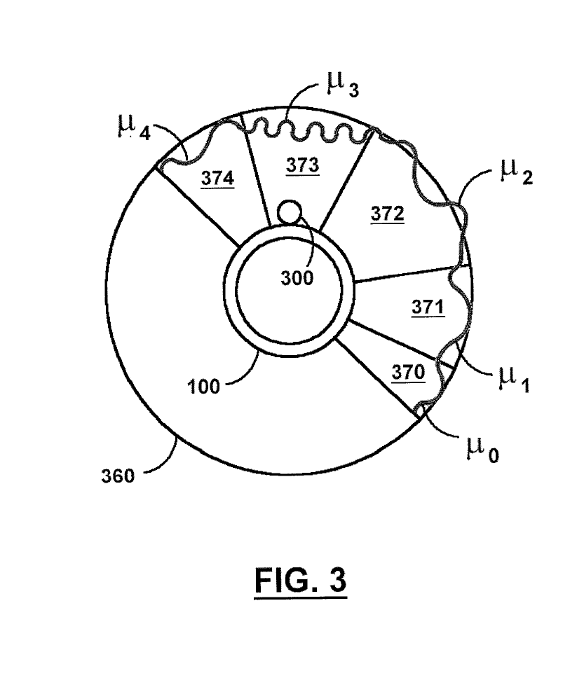

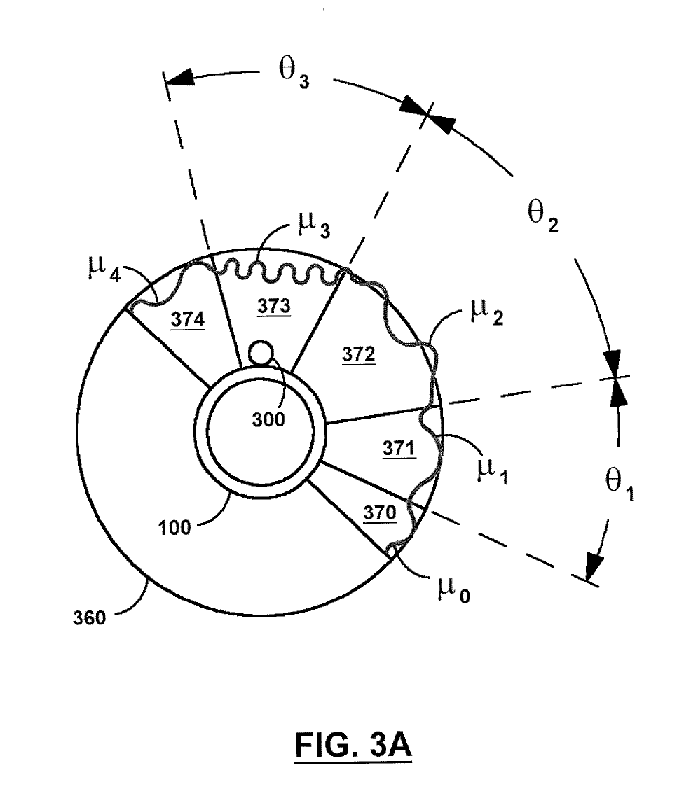

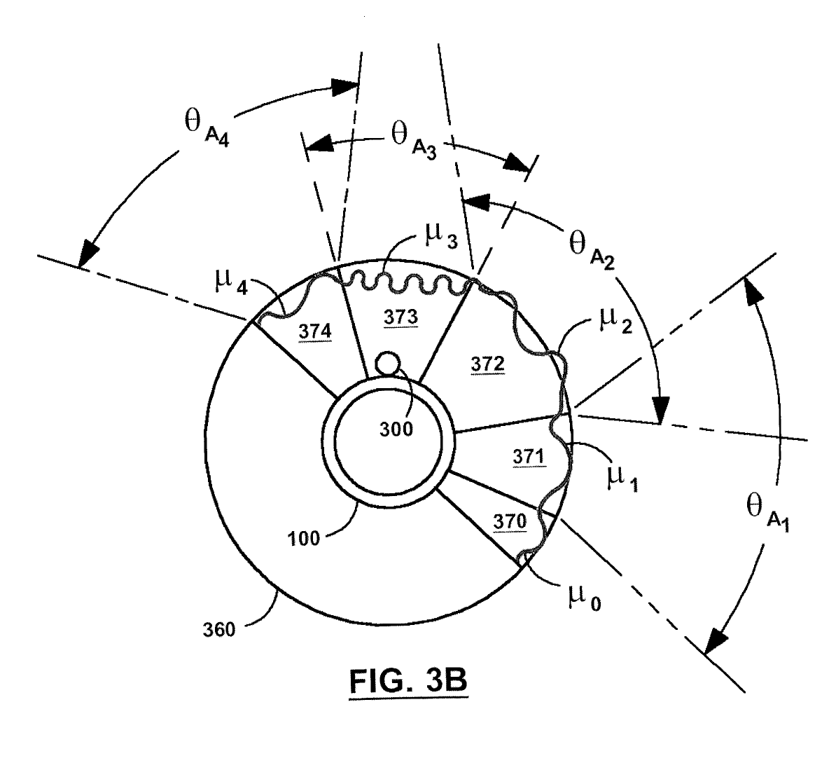

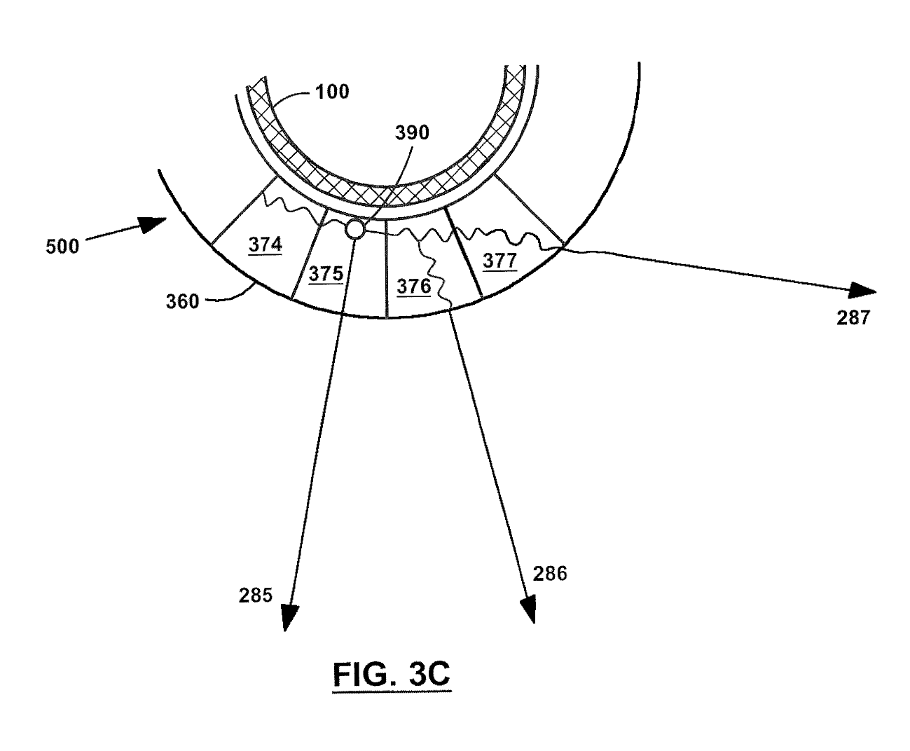

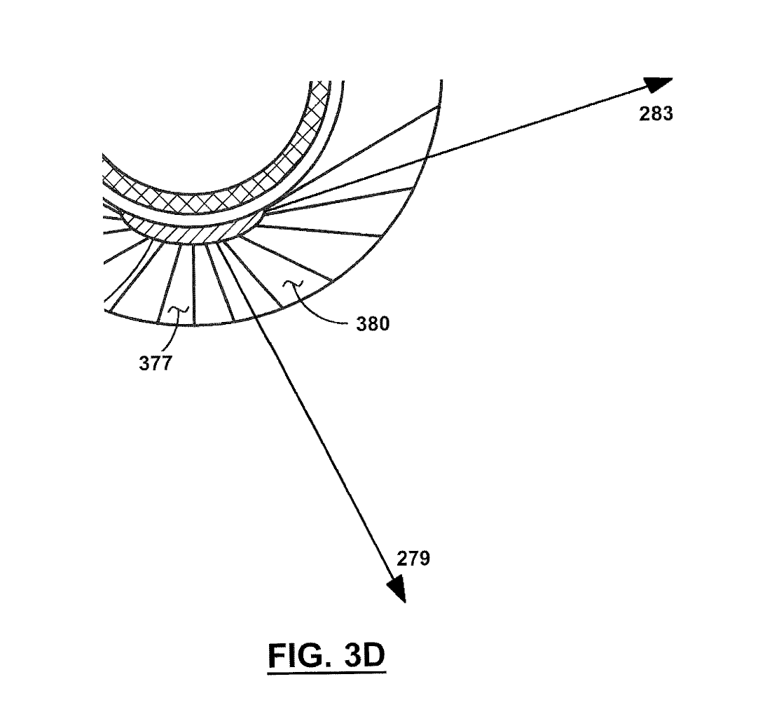

In one embodiment of the invention, the varying permeability creating the selected lensing of the transmitted magnetic flux may be comprised of alternating sections of the coating over the lensed magnetic antenna 360. Each segment will have selected permeability variations of one (e.g., stainless steel) and ten (a semi-saturated ferromagnetic material). The resulting signals into the media would be coded at the separation angle of the lens segments and shown in FIGS. 3B, 3C and 3D.

FIG. 2 illustrates a differing configuration wherein the transmitter 300 is not adjacent to each separate lens segment of the antenna collar 360. In contrast to FIG. 1 and 1A, an oscillating magnetic flux signal from the transmitter 300 may pass through several differing segments of the antenna, e.g., 373 and 374 prior to being emitted from the antenna segment 375 in the altered phase and direction. This is shown in FIG. 2A by the path of signal vectors 281, 283, 284, and 287. It will be appreciated that FIGS. 1, 1A, 2 and 2A do not show the means of the apparatus 500 for receiving a separate oscillating flux signal that may be generated from eddy currents induced within target objects from oscillating magnetic flux emitted from various segments, e.g. 373, 374 and 375, of the antenna collar 360.

FIG. 3 illustrates the antenna segments 370 through 374 have differing magnetic permeability, shown as μ₀-μ₄ respectively.

FIG. 3A illustrates the arc of out surface of each antenna segment. It will be appreciated that each arc, e.g., θ₁ θ₂ and θ₃, are co-terminus and that there is no overlap.

FIG. 3B illustrates an arc of angle θ_{A} within which a transmitted signal may be emitted from a particular antenna segment. It will be appreciated that the arc may also overlap with the arc of at least the next adjacent antenna segment. This is shown by the overlap of arc θ_{A4} of possible signal transmission from segment 374 with the possible transmission arc θ_{A3} from segment 373. The direction and phase of emitted signals (not shown) provides a marker or coding as to the origin of the oscillating magnetic flux. An electrically conductive object located outside of the antenna collar 360 may be engaged with flux emitted from one or more antenna segments. Eddy currents may be generated within the object through well-understood electromechanical principles. The eddy currents and resulting magnetic flux will have properties characteristic of the phase and direction of the magnetic flux from the applicable antenna segment, e.g. 374, 372. . This will accordingly provide information regarding the location of the object or the media that is responding to the flux transmitted by the lensed magnetic antenna. The specific length and geometry of the arc will be a function of the permeability and conductivity of the antenna section, the degree that the relative permeability of the segment is reduced, the configuration of the lensing segments comprising the magnetic flux antenna, and the properties of eddy currents induced within the antenna segments.

FIG. 3C illustrates that the multiple segments, and associated differing permeability and conductivity may achieve the directional lensing of oscillating flux. It will be appreciated that the directional orientation or vector of flux, 286 and 287, emitted from certain segments, 376 and 377, will not be normal to the outer surface (“second surface”) of the respective segments of the antenna configuration. This can be contrasted to the vector 285 representing flux emitted from 385. It will of course be appreciated that this directionality will be impacted or achieved in part by the properties of the eddy currents induced in the separate antenna segments. FIG. 3D also illustrates the directionality achieved in flux vectors 279 and 283 emitted from the differing antenna segments.

In some embodiments of the invention, it may be desired to place electrical insulating material (not shown) between antenna segments to reduce cross transmission of eddy currents.

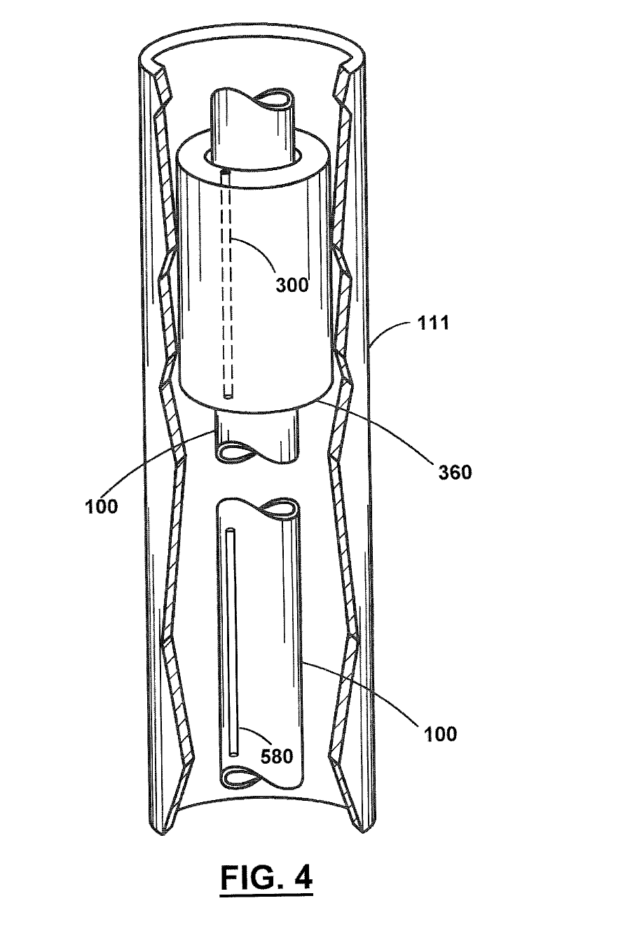

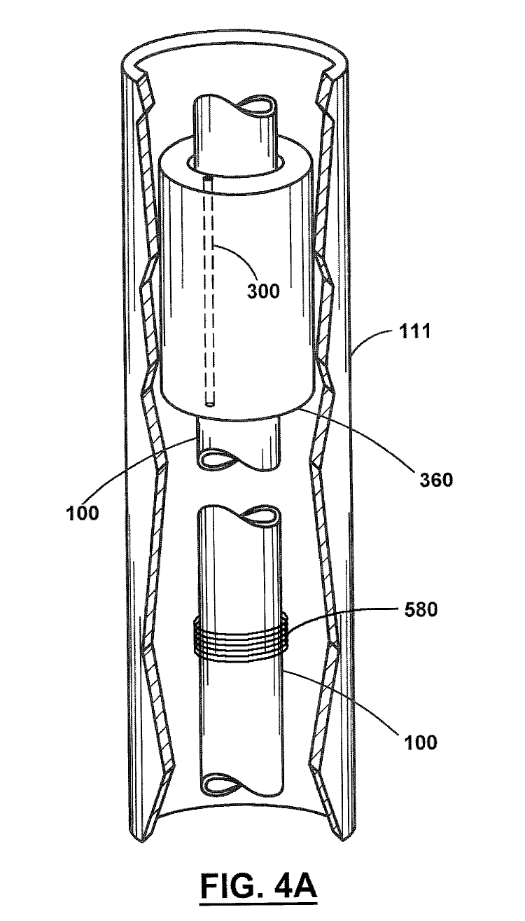

FIG. 4 illustrates a configuration of the invention wherein a receiver device 580 is placed on the production tubing 100 at a location separate from the magnetic flux antenna 360. The separation of the transmitter 300 and the receiver 580 may facilitate nulling of the direct transmission of signal. It is envisioned that the device may be used in conjunction with well casing 111 not comprising an EM barrier, e.g., stainless steel, etc.

The lens segments may vary in thickness, causing like permeable materials to create varying phase shifting in the transmitted oscillating flux through the lens at different points by different amounts. This phase shifting occurs because the permeable material absorbs oscillating flux in proportion to the permeability value of the material and its thickness. In two dimensions, this phenomenon is shown in FIG. 4.

FIG. 4A illustrates an alternate configuration wherein the receiver 580 is oriented around the entire outer diameter of the production tubing 100. It will be appreciated that in other embodiments, the axis of the receiver may be located orthogonal to the axis of the transmitter 300 or antenna collar 360. Further, multiple receivers may be utilized, each oriented in a specified manner to the antenna or transmitter and thereby providing multiple reference points for determining the location of target objects possessing electrically conductive properties with the area of interest. Examples can include the location of water or the water within a hydrocarbon reservoir. In yet other embodiments, multiple receivers may be configured with opposing or bucked direction of windings.

The varying conductivity and permeability of the different antenna segments will further impact the characteristics (phase, frequency or amplitude) of the oscillating flux emitted from the differing antenna segments. It will be appreciated that flux engaging the differing segments will induce eddy currents within the segment. As a result of the skin depth phenomena, the largest concentration of eddy currents will be at the surface of the segment most adjacent to the transmitter. However, increased transmission of magnetic flux will reduce the permeability of at least some portions of the segments, particularly in the area most adjacent to the transmitter. As the permeability is reduced the skin depth increases. At a point at which a portion of the segment is sufficiently saturated such that eddy currents are induced at the opposite surface of segments, the skin effect will again cause the eddy currents to extend along this second surface of the antenna segment.

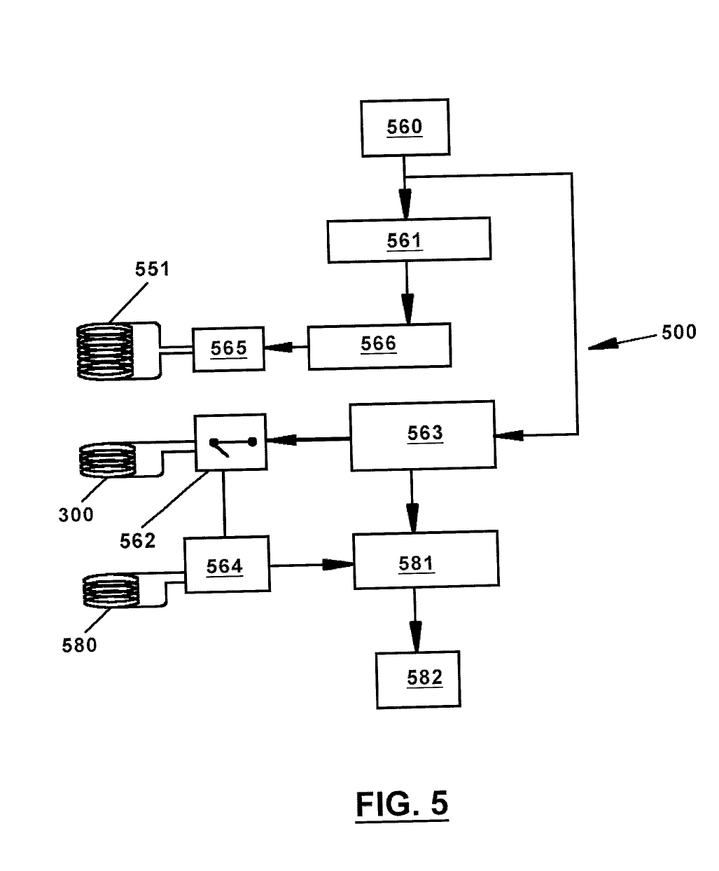

FIG. 5 illustrates some of the components utilized in the oscillating magnetic flux embodiment of the invention. Such components include a power supply 560, a signal generator 563, transmitter 300, receiver 580, amplifier 564, signal converter 581 and an output display 582. Also show in a separate saturation flux generator 551 utilized to reduce the permeability of antenna segments.

Persons skilled in the technology will appreciate it after reading this application that available equipment and techniques for generating other forms of energy signals, such as acoustic signals, may be transmitted through various materials that may alter the phase and directional orientation of the signal. Further, that alteration of the phase and directionality from a single source may provide information concerning the location or direction of objects responding to impingement with one or more such distinguishable signals.

What I claim is:

1. An apparatus for transmitting oscillating magnetic flux comprising:
a. a plurality of materials placed in an antenna configuration having a first surface and a second surface,
b. at least one material having a different magnetic permeability than the other materials,
c. a magnetic flux generator proximate to the first surface to transmit and engage oscillating magnetic flux into the first surface, and
d. a receiver device to receive oscillating magnetic flux.

2. The apparatus of claim 1 wherein oscillating magnetic flux resulting from the magnetic flux generator and emitted from a portion of the second surface of the antenna has a differing phase from oscillating magnetic flux emitted from the second surface of a differing portion of the antenna.

3. The apparatus of claim 2 wherein at least one of the differing phased magnetic flux is directionally oriented.

4. The apparatus of claim 1, 2, or 3 further comprising a receiver nulled to the magnetic flux generator and flux emitted from the second surface of the antenna.

5. The apparatus of claim 5 wherein the nulled relationship of the receiver is achieved by geometric orientation of the receiver.

6. The apparatus of claim 5 wherein the nulled relationship of the receiver is achieved by electronic nulling.

7. The apparatus of claim 5 wherein the nulled relationship of the receiver is achieved by a spatial relationship between the receiver, transmitter and second surface of the material.

8. The apparatus of claim 5 wherein the differing phase of at least one oscillating magnetic flux is related to the directional orientation of the oscillating flux

9. The apparatus of claim 5 wherein the directional orientation of the oscillating flux inducing a received signal is related to the phase of the received signal.

10. An apparatus for transmitting oscillating magnetic flux comprising:
a. A plurality of materials placed in an antenna configuration having a first surface and a second surface,
b. a source of first magnetic flux proximate to the first antenna surface,
c. an oscillating magnetic flux generator proximate to the first antenna surface to transmit and engage oscillating magnetic flux into the first surface, and
d. a receiver device to receive oscillating magnetic flux.

11. The apparatus of claim 10 wherein at least a portion of the antenna configuration is partially saturated with the first magnetic flux.

12. The apparatus of claim 1, 2 or 11 wherein the magnetic field induced by the eddy currents alters at least one of group comprising magnetic flux phase and directional orientation of magnetic flux emitted from the second surface of at least one portion of the antenna.

14. The apparatus of claim 11 further comprising a controller to control the extent of partial saturation of the magnetically permeable material.

15. A method for creating a lensed magnetic antenna comprising:
a. selecting a plurality of materials of which at least one of the selected materials has a differing permeability,
b. placing the materials in a determined antenna configuration having a first surface and an outer second surface,
c. engaging at least a portion of the antenna configuration with an oscillating magnetic flux,
d. transmitting oscillating magnetic flux from at least a portion of the outer second antenna surface, and
e. receiving signals from electrically conductive objects.

16. The method of claim 15 further comprising inducing eddy currents in electrically conductive objects engaged with oscillating flux emitted from the outer second antenna surface.

17. The method of claim 16 further comprising detecting the phase of oscillating flux received.

18. The method of claim 17 further wherein the phase and time of received oscillating flux is correlated to the antenna configuration.
